(19) United States
(12) Patent Application Publication
(10) Pub. No.: US 2019/0377359 A1
(43) Pub. Date: Dec. 12, 2019

(54) NAVIGATION SYSTEM WITH VEHICLE OPERATION MECHANISM AND METHOD OF OPERATION THEREOF

(71) Applicant: Telenav, Inc., Santa Clara, CA (US)

(72) Inventors: Ninad Pradeep Lanke, Milpitas, CA (US); Sarvesh Bansilal Devi, Milpitas, CA (US)

(21) Appl. No.: 16/006,291

(22) Filed: Jun. 12, 2018

(51) Int. Cl. G05D 1/02

(52) U.S. Cl. CPC G05D 1/0276; G05D 2201/0213; G05D 1/0223

(57) ABSTRACT

A method of operation of a navigation system includes determining a vehicle type of a surrounding vehicle based on comparing a capture data to a trained data; determining a vehicle attribute of the surrounding vehicle based on comparing the capture data to the trained data; determining a vehicle position relative to a current location based on a vehicle distance meeting or exceeding a distance threshold; and controlling a vehicle operation with a control unit based on the vehicle type, the vehicle attribute, the vehicle position, or a combination thereof for adjusting the vehicle distance between a user's vehicle and a surrounding vehicle.

### TECHNICAL FIELD

The present invention relates generally to a navigation system, and more particularly to a system with vehicle operation mechanism.

### BACKGROUND ART

Modern portable consumer and industrial electronics, especially client devices such as navigation systems, cellular phones, portable digital assistants, and combination devices, are providing increasing levels of functionality to support modern life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use location information to provide navigation services such as a global positioning system (GPS) for a car or on a mobile device such as a cell phone, portable navigation device (PND) or a personal digital assistant (PDA).

Location based services allow users to create, transfer, store, and/or consume information in order for users to create, transfer, store, and consume in the “real world.” One such use of location based services is to efficiently transfer or route users to the desired destination or service.

Navigation systems and location based services enabled systems have been incorporated in automobiles, notebooks, handheld devices, and other portable products. Today, these systems aid users by incorporating available, real-time relevant information, such as maps, directions, local businesses, or other points of interest (POI). The real-time information provides invaluable relevant information.

However, a navigation system improving a mechanism to control vehicle operation become a paramount concern for the consumer. The inability decreases the benefit of using the tool.

Thus, a need still remains for a navigation system with vehicle operation mechanism to a device during operation of vehicle. In view of the increasing mobility of the workforce and social interaction, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: determining a vehicle type of a surrounding vehicle based on comparing a capture data to a trained data; determining a vehicle attribute of the surrounding vehicle based on comparing the capture data to the trained data; determining a vehicle position relative to a current location based on a vehicle distance meeting or exceeding a distance threshold; and controlling a vehicle operation with a control unit based on the vehicle type, the vehicle attribute, the vehicle position, or a combination thereof for adjusting the vehicle distance between a user's vehicle and a surrounding vehicle.

The present invention provides a navigation system, including: a control unit for: determining a vehicle type of a surrounding vehicle based on comparing a capture data to a trained data; determining a vehicle attribute of the surrounding vehicle based on comparing the capture data to the trained data; determining a vehicle position relative to a current location based on a vehicle distance meeting or exceeding a distance threshold; controlling a vehicle operation based on the vehicle type, the vehicle attribute, the vehicle position, or a combination thereof; and a communication unit, coupled to the control unit, for transmitting the vehicle operation for adjusting the vehicle distance between a user's vehicle and a surrounding vehicle.

The present invention provides a navigation system having a non-transitory computer readable medium including instructions for execution, the instructions comprising: determining a vehicle type of a surrounding vehicle based on comparing a capture data to a trained data; determining a vehicle attribute of the surrounding vehicle based on comparing the capture data to the trained data; determining a vehicle position relative to a current location based on a vehicle distance meeting or exceeding a distance threshold; and controlling a vehicle operation based on the vehicle type, the vehicle attribute, the vehicle position, or a combination thereof for adjusting the vehicle distance between a user's vehicle and a surrounding vehicle.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a navigation system with vehicle operation mechanism in an embodiment of the present invention.

FIG. 2 is an example of a travel context.

FIG. 3 is an example of a vehicle operation.

FIG. 4 is an exemplary block diagram of the navigation system.

FIG. 5 is a control flow of the navigation system.

FIG. 6 is a flow chart of a method of operation of the navigation system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the navigation system are semi-diagrammatic and not to scale and, particularly, some of the dimensions are for the clarity of presentation and are shown exaggerated in the drawing FIGS. Similarly, although the views in the drawings for ease of description generally show similar orientations, this depiction in the FIGS. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims section below, the modules are deemed to include hardware circuitry for the purposes and the scope of apparatus claims.

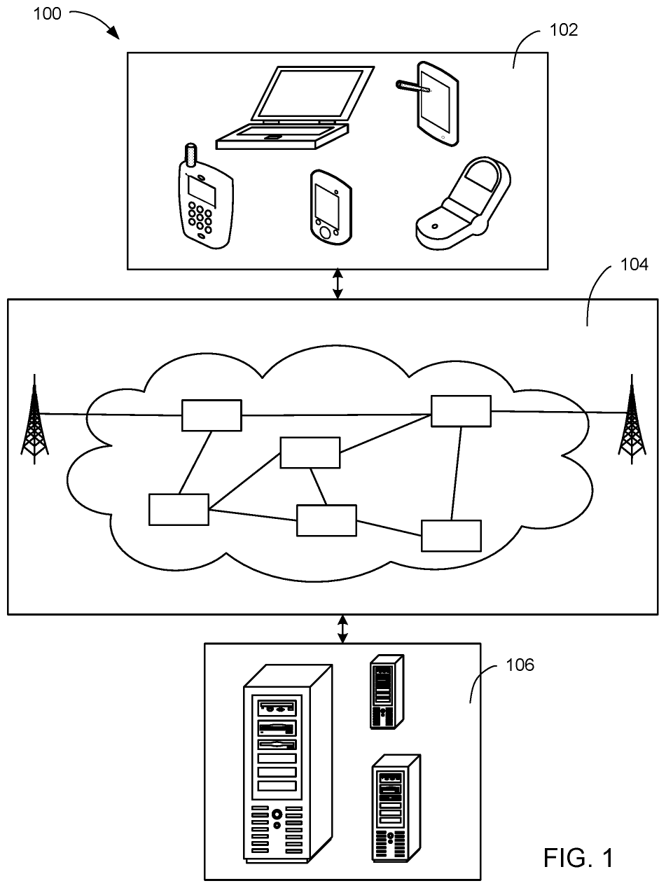

Referring now to FIG. 1, therein is shown a navigation system 100 with vehicle operation mechanism in an embodiment of the present invention. The navigation system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic navigation system, a head unit, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the navigation system 100 is described with the first device 102 as a mobile computing device, although it is understood that the first device 102 can be different types of computing devices. For example, the first device 102 can also be a non-mobile computing device, such as a server, a server farm, or a desktop computer. In another example, the first device 102 can be a particularized machine, such as a mainframe, a server, a cluster server, rack mounted server, or a blade server, or as more specific examples, an IBM System z10 ™ Business Class mainframe or a HP ProLiant ML™ server.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102. Another example, the first device 102 or the second device 106 can be a particularized machine, such as a portable computing device, a thin client, a notebook, a netbook, a smartphone, a tablet, a personal digital assistant, or a cellular phone, and as specific examples, an Apple iPhone™, Android™ smartphone, or Windows™ platform smartphone.

For illustrative purposes, the navigation system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

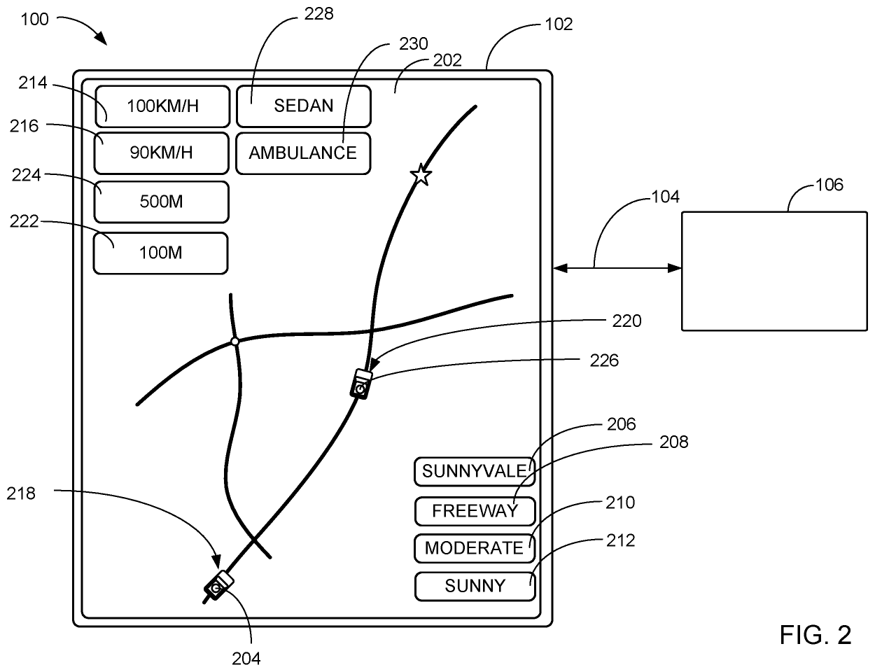

Referring now to FIG. 2, there is shown an example of a travel context 202. For clarity and brevity, the discussion of the embodiment of the present invention will focus on the first device 102 delivering the result generated by the navigation system 100. However, the second device 106 and the first device 102 can be discussed interchangeably. The first device 102 and the second device 106 can communicate via the communication path 104.

The travel context 202 is defined as a situation or circumstance surrounding the first device 102 while traveling. The travel context 202 can include a current location 204, a geographic area 206, a road type 208, a traffic condition 210, a weather condition 212, or a combination thereof. The current location 204 is defined as a physical location of the first device 102. For example, the current location 204 can represent the GPS coordinates of first device 102 currently detected by the navigation system 100.

The geographic area 206 is defined as a geographic region. For example, the geographic area 206 can represent the geographic region traveled by the user with the first device 102. The road type 208 is defined as a classification of the road. For example, the road type 208 can include a local road, arterial road, expressway, highway, freeway, or a combination thereof.

The traffic condition 210 is defined as a status of the traffic flow. For example, the traffic condition 210 can include no traffic, light traffic, moderate traffic, heavy traffic, standstill, or a combination thereof. The traffic condition 210 can exist within the geographic area 206, the road type 208, or a combination thereof.

The weather condition 212 is defined as a state of the atmosphere with respect to wind, temperature, cloudiness, moisture, pressure, or a combination thereof. The weather condition 212 can include sunny, cloudy, rainy, foggy, windy, stormy, cold, mild, hot, hail, snow, or a combination thereof.

A travel speed 214 is defined as a rate of motion for traveling. For example, the travel speed 214 traveling on the freeway can be faster than the travel speed 214 traveling on a local road. A speed limit 216 is defined as government regulated speed on the road type 208. For example, the speed limit 216 on the road type 208 representing the freeway can represent 100 kilometers per hour.

A user's vehicle 218 can represent a vehicle traveled by the user of first device 102. For example, the user's vehicle 218 can be integrated with the first device 102. A surrounding vehicle 220 can represent a vehicle other than the user's vehicle 218. For example, the surrounding vehicle 220 can be traveling on the same road as the user's vehicle 218.

For further example, the surrounding vehicle 220 can represent a vehicle within a distance threshold 222. The distance threshold 222 is defined as a limit for a vehicle distance 224. For example, the distance threshold 222 can represent a minimum or maximum distance for the vehicle distance 224. The surrounding vehicle 220 can represent a vehicle within the distance threshold 222.

The vehicle distance 224 is defined as a physical distance between vehicles. For example, the vehicle distance 224 can represent the physical distance between the user's vehicle 218 and the surrounding vehicle 220. More specifically as an example, the vehicle distance 224 can represent the physical distance measured from the user's vehicle 218 in cardinal directions, intercardinal directions, or a combination thereof.

For example, a vehicle position 226 of the surrounding vehicle 220 can be North East from the current location 204 of the user's vehicle 218. The vehicle position 226 is defined as the physical location of the surrounding vehicle 220. For example, the vehicle position 226 can represent the GPS coordinates detected by the navigation system 100.

A vehicle type 228 is defined as a classification of a vehicle. For example, the vehicle type 228 can include a passenger vehicle, a commercial vehicle, a truck, a bus, a special vehicle 230, or a combination thereof. The special vehicle 230 can include a police car, an ambulance, a firetruck, or a combination thereof.

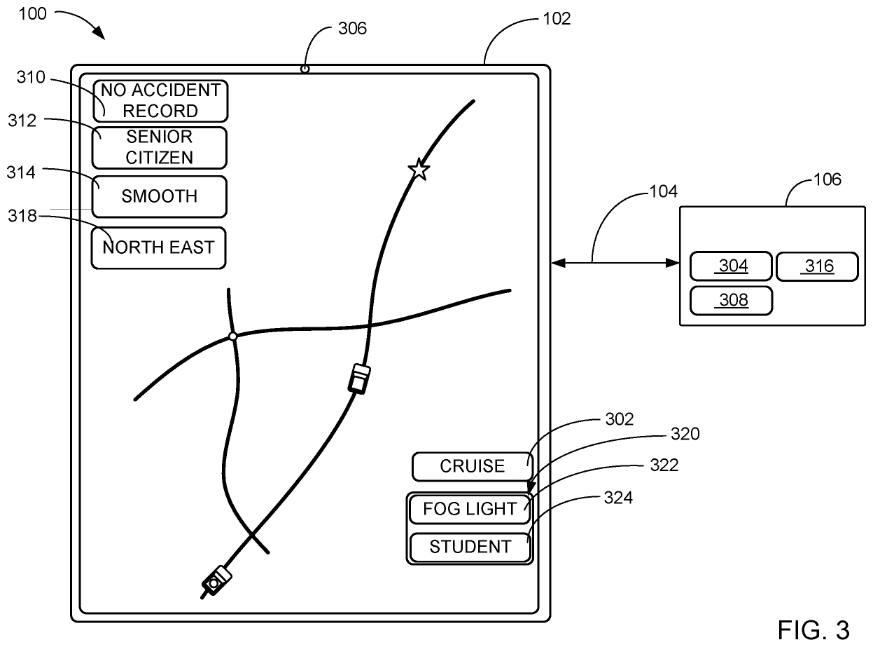

Referring now to FIG. 3, there is shown a vehicle operation 302. For clarity and brevity, the discussion of the embodiment of the present invention will focus on the first device 102 delivering the result generated by the navigation system 100. However, the second device 106 and the first device 102 can be discussed interchangeably. The first device 102 and the second device 106 can communicate via the communication path 104.

The vehicle operation 302 is defined as an action to maneuver a vehicle. For example, the vehicle operation 302 can include accelerating, decelerating, turning, backing up, setting a cruise control, stopping, or a combination thereof.

The navigation system 100 can control the vehicle operation 302 based on various factors. For example, the navigation system 100 can obtain a capture data 304 with a capturing device 306. The capturing device 306 For example, the capturing device 210 can include a digital camera, video camera, thermal camera, night vision camera, infrared camera, x-ray camera, or the combination thereof. The user's vehicle 218 of FIG. 2 can include multiple instances of the capturing device 306 placed in various location on the user's vehicle 218.

The capture data 304 can represent information or data captured by the capturing device 306. For example, the capture data 304 can represent digital image, video image, temperature, precipitation, biometric information, or a combination thereof.

A trained data 308 can represent information stored by the navigation system 100 to identify the content of the capture data 304. For example, the navigation system 100 can apply artificial intelligence technology including machine learning, deep learning, computer vision, or a combination thereof to determine the capture data 304 by comparing the capture data 304 to the trained data 308.

An operation profile 310 is defined as a characterization of one's vehicle operation. For example, the navigation system 100 can generate the operation profile 310 for a user, another user, or a combination thereof.

More specifically as an example, the operation profile 310 can include a driver profile 312, an operation pattern 314, an activity history 316, or a combination thereof. The driver profile 312 is defined as personal information regarding the operator of the vehicle. For example, the driver profile 312 can include age, sex, profession, health condition, family status, race, citizenship, or a combination thereof.

The activity history 316 is defined as record of operating the vehicle. For example, the activity history 316 can include the user's vehicle 218 traveling in the geographic area 206 representing Tokyo, Japan in late August. The operation pattern 314 can represent habitual series of action. For example, the operation pattern 314 can indicate that the user's vehicle changes to a lane closest to the off ramp of a freeway around 50 meter from the exit. For another example, the operation pattern 314 can indicate that the user drives on the slowest lane when the traffic condition 210 of FIG. 2 is heavy traffic.

An operation heading 318 is defined as a direction, which the vehicle is moving towards. For example, the operation heading 318 can head towards each of the cardinal direction, intercardinal direction, or a combination thereof.

A vehicle attribute 320 is defined is a characteristic of the vehicle. For example, the vehicle attribute 320 can include a vehicle feature 322, an addendum feature 324, or a combination thereof. For example, the vehicle feature 322 can include an original component of the vehicle including a bumper, shape of the door, headlights, wheel size, vehicle size, or a combination thereof. For another example, the addendum feature 324 can include component added to the vehicle. For a specific example, the addendum feature 324 can include a sticker, a spoiler, tint on the window, or a combination thereof.

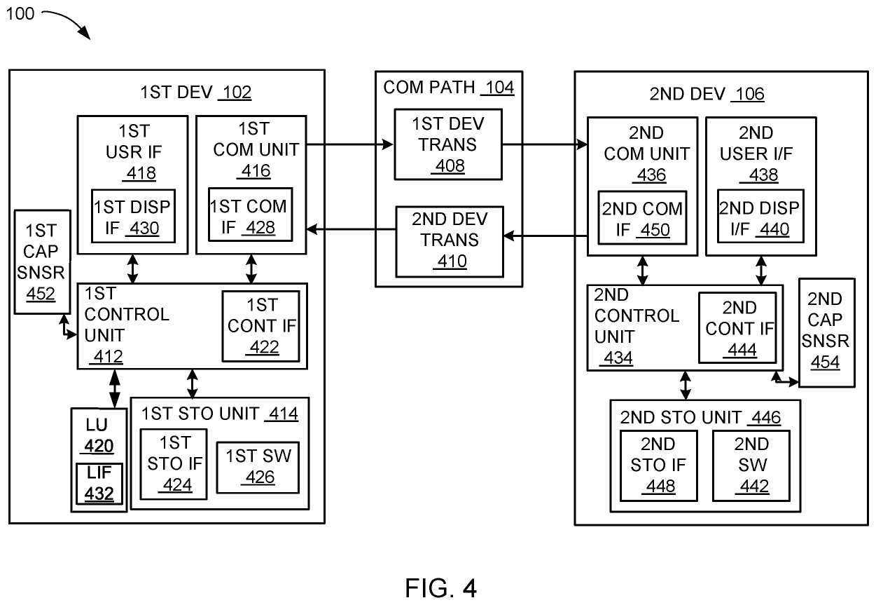

Referring now to FIG. 4, therein is shown an exemplary block diagram of the navigation system 100. The navigation system 100 can include the first device 102, the communication path 104, and the second device 106. The first device 102 can send information in a first device transmission 408 over the communication path 104 to the second device 106. The second device 106 can send information in a second device transmission 410 over the communication path 104 to the first device 102.

For illustrative purposes, the navigation system 100 is shown with the first device 102 as a client device, although it is understood that the navigation system 100 can have the first device 102 as a different type of device. For example, the first device 102 can be a server.

Also for illustrative purposes, the navigation system 100 is shown with the second device 106 as a server, although it is understood that the navigation system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 412, a first storage unit 414, a first communication unit 416, a first user interface 418, and a location unit 420. The first control unit 412 can include a first control interface 422. The first control unit 412 can execute a first software 426 to provide the intelligence of the navigation system 100. The first control unit 412 can be implemented in a number of different manners. For example, the first control unit 412 can be a processor, an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations physically separate from the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The location unit 420 can generate location information, current heading, and current speed of the first device 102, as examples. The location unit 420 can be implemented in many ways. For example, the location unit 420 can function as at least a part of a global positioning system (GPS), an inertial navigation system, a cellular-tower location system, a pressure location system, or any combination thereof.

The location unit 420 can include a location interface 432. The location interface 432 can be used for communication between the location unit 420 and other functional units in the first device 102. The location interface 432 can also be used for communication that is external to the first device 102.

The location interface 432 can receive information from the other functional units or from external sources, or can transmit information to the other functional units or to external destinations. The external sources and the external destinations refer to sources and destinations physically separate from the first device 102.

The location interface 432 can include different implementations depending on which functional units or external units are being interfaced with the location unit 420. The location interface 432 can be implemented with technologies and techniques similar to the implementation of the first control interface 422.

The first storage unit 414 can store the first software 426. The first storage unit 414 can also store the relevant information, such as advertisements, points of interest (POI), navigation routing entries, or any combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the location unit 420 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations physically separate from the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106, an attachment, such as a peripheral device or a computer desktop, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, a camera, or any combination thereof to provide data and communication inputs.

The first user interface 418 can include a first display interface 430. The first display interface 430 can include a display, a projector, a video screen, a speaker, a headset, or any combination thereof.

The first control unit 412 can operate the first user interface 418 to display information generated by the navigation system 100. The first control unit 412 can also execute the first software 426 for the other functions of the navigation system 100, including receiving location information from the location unit 420. The first control unit 412 can further execute the first software 426 for interaction with the communication path 104 via the first communication unit 416.

The second device 106 can be optimized for implementing the present invention in a multiple device embodiment with the first device 102. The second device 106 can provide the additional or higher performance processing power compared to the first device 102. The second device 106 can include a second control unit 434, a second communication unit 436, and a second user interface 438.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, a camera, or any combination thereof to provide data and communication inputs. Examples of the output device of the second user interface 438 can include a second display interface 440. The second display interface 440 can include a display, a projector, a video screen, a speaker, a headset, or any combination thereof.

The second control unit 434 can execute a second software 442 to provide the intelligence of the second device 106 of the navigation system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the navigation system 100, including operating the second communication unit 436 to communicate with the first device 102 over the communication path 104.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations physically separate from the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the navigation system 100 is shown with the second storage unit 446 as a single hierarchy storage system, although it is understood that the navigation system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the location unit 420 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations physically separate from the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The navigation system 100 can be executed by the first control unit 412, the second control unit 434, or a combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the navigation system 100 is described by operation of the first device 102 and the second device 106. It is understood that the first device 102 and the second device 106 can operate any of the modules and functions of the navigation system 100. For example, the first device 102 is described to operate the location unit 420, although it is understood that the second device 106 can also operate the location unit 420.

A first capturing sensor 452 can represent the capturing device 306 of FIG. 3. Examples of the first capturing sensor 452 can include a digital camera, video camera, thermal camera, night vision camera, infrared camera, x-ray camera, ultraviolet camera, or the combination thereof. Examples of the first capturing sensor 452 can further include accelerometer, thermometer, microphone, wireless signal receiver, remote physiological monitoring device, light identifier, or the combination thereof.

A second capturing sensor 454 can represent the capturing device 306. Examples of the second capturing sensor 454 can include a digital camera, video camera, thermal camera, night vision camera, infrared camera, x-ray camera, ultraviolet camera, or the combination thereof. Examples of the second capturing sensor 454 can further include accelerometer, thermometer, microphone, wireless signal receiver, remote physiological monitoring device, light identifier, or the combination thereof.

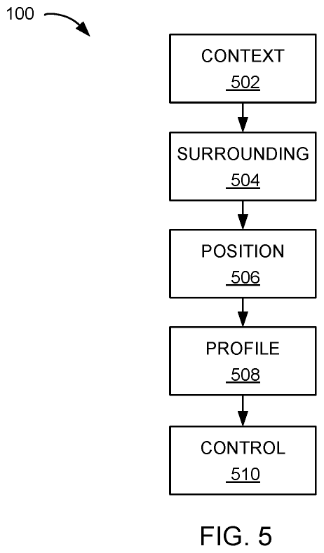

Referring now to FIG. 5, therein is shown a control flow of the navigation system 100. The navigation system 100 can include a context module 502. The context module 502 determines the travel context 202 of FIG. 2. For example, the context module 502 can determine the travel context 202 based on the current location 204 of FIG. 2, the geographic area 206 of FIG. 2, the road type 208 of FIG. 2, the traffic condition 210 of FIG. 2, the weather condition 212 of FIG. 2, the travel speed 214 of FIG. 2, the capture data 304 of FIG. 3, or a combination thereof.

The context module 502 can determine the travel context 202 in a number of ways. For example, the context module 502 can determine the travel context 202 based on the current location 204, the road type 208, or a combination thereof. More specifically as an example, the location unit 420 of FIG. 4 can determine the GPS coordinates of the first device 102 of FIG. 1, the user's vehicle 218 of FIG. 2, or a combination thereof as the current location 204 within the geographic area 206. The geographic area 206 can represent Los Angeles, Calif. For further example, the current location 204 can be detected on the road type 208 representing a freeway to indicate that the user is currently traveling on the freeway. Based on the current location 204, the geographic area 206, the road type 208, the context module 502 can determine the travel context 202 as the user is currently traveling on the freeway within Los Angeles.

For a different example, the context module 502 can determine the travel context 202 based on the traffic condition 210. More specifically as an example, the traffic condition 210 can include traffic flow such as no traffic, light traffic, moderate traffic, heavy traffic, standstill, or a combination thereof. The context module 502 can determine the travel context 202 based on the information regarding the traffic condition 210 provided by external sources. For example, the external source can represent government agency providing traffic information.

For another example, the context module 502 can determine the traffic condition 210 based on the travel speed 214, the speed limit 216 of FIG. 2, or a combination thereof. More specifically as an example, the context module 502 can determine the traffic condition 210 based on comparing the travel speed 214 to the speed limit 216 for the road type 208. For further example, the context module 502 can determine the traffic condition 210 based on the granular or percentage difference between the travel speed 214 and the speed limit 216.

For a specific example, the context module 502 can determine the traffic condition 210 as no traffic if there is no difference between the travel speed 214 and the speed limit 216. For a different example, the context module 502 can determine the traffic condition 210 as standstill if the travel speed 214 is at zero. For another example, the context module 502 can determine the traffic condition 210 as moderate traffic if the travel speed 214 meets or below the speed limit 216 by 20%. For further example, the context module 502 can determine the traffic condition 210 as heavy traffic if the travel speed 214 meets or below the speed limit 216 by 50% or greater. Based on the traffic condition 210 determined, the context module 502 can determine the travel context 202 representing the type of traffic flow that the user is currently traveling.

For a different example, the context module 502 can determine the travel context 202 based on the weather condition 212 received from the external source, the capture data 304, or a combination thereof. More specifically as an example, the capturing device 306 of FIG. 3 can capture the capture data 304 representing the precipitation. Based on the capture data 304, the context module 502 can determine whether the travel context 202 representing user is traveling in rain or not. For another example, the context module 502 can determine the travel context 202 based on the weather condition 212 forecasted by the external source. The context module 502 can transmit the travel context 202 to a surrounding module 504.

The navigation system 100 can include the surrounding module 504, which can be coupled to the context module 502. The surrounding module 504 determines the surrounding vehicle 220 of FIG. 2. For example, the surrounding module 504 can determine the surrounding vehicle 220 based on the capture data 304, the vehicle type 228 of FIG. 2, the vehicle attribute 320 of FIG. 3, the trained data 308 of FIG. 3, or a combination thereof.

The surrounding module 504 can determine the surrounding vehicle 220 in a number of ways. For example, the surrounding module 504 can determine the surrounding vehicle 220 based on comparing the capture data 304 to the trained data 308. More specifically as an example, the surrounding module 504 can compare the capture data 304 to the trained data 308 based on artificial intelligence technology including machine learning, deep learning, computer vision, or a combination thereof.

As discussed above, the user's vehicle 218 can include one instance or multiple instances of the capturing device 306. More specifically as an example, each of the capturing device 306 can be placed in the front, each side, the rear, the bottom, the top, or a combination thereof of the user's vehicle 218 to capture the images surrounding the user's vehicle 218 in 360 degrees. For a different example, a single instance of the capturing device 306 with the capability of 360 degree view to capture the surrounding vehicle 220 can be placed on the user's vehicle 218. The surrounding module 504 can determine each instance of the surrounding vehicle 220 surrounding the user's vehicle 218 based on the capturing device 306 capturing the capture data 304. The capture data 304 can represent an image of the surrounding vehicle 220.

Continuing with the example, the surrounding module 504 can determine the surrounding vehicle 220 based on comparing the capture data 304 to the trained data 308. More specifically as an example, the surrounding module 504 can determine the surrounding vehicle 220 including the vehicle type 228, the vehicle attribute 320, or a combination thereof.

For a specific example, the surrounding module 504 can determine the vehicle type 228. The trained data 308 stored in the first device 102, the second device 106 of FIG. 2, or a combination thereof can represent images of different models of the vehicle type 228. The surrounding module 504 can compare the capture data 304 to the trained data 308 to determine whether the capture data 304 represents a specific instance of the vehicle type 228. If there is a match between the capture data 304 and the trained data 308, the surrounding module 504 can determine the vehicle type 228. For a specific example, the surrounding module 504 can determine the surrounding vehicle 220 as the vehicle type 228 representing a motorcycle, a passenger vehicle, a truck, a bus, or the special vehicle 230 of FIG. 2 based on comparing the capture data 304 to the trained data 308. For further example, the surrounding module 504 can determine the specific brand for the vehicle type 228 based on comparing the capture data 304 to the trained data 308.

For another example, the surrounding module 504 can determine the vehicle attribute 320. More specifically as an example, the surrounding module 504 can determine the vehicle attribute 320 based on the vehicle feature 322 of FIG. 3, the addendum feature 324 of FIG. 3, or a combination thereof. For a specific example, the surrounding module 504 can determine the vehicle attribute 320 based on comparing the capture data 304 to the trained data 308.

The capturing device 306 can capture the image of the surrounding vehicle 220 to generate the capture data 304. The surrounding vehicle 220 can represent another vehicle. The capture data 304 can include the image representing the vehicle feature 322 including the contour of another vehicle, headlight shape, window shape, number of doors, or a combination thereof. For another example, the capture data 304 can include the image representing the addendum feature 324 including “baby on board” sticker, “student driver” sticker, “oversized load” notification, or a combination thereof. The surrounding module 504 can determine the vehicle attribute 320 by comparing each of the capture data 304 to the trained data 308 to identify each of the vehicle attribute 320. The surrounding module 504 can transmit the surrounding vehicle 220 to a position module 506.

The navigation system 100 can include the position module 506, which can be coupled to the surrounding module 504. The position module 506 determines the vehicle position 226 of FIG. 2. For example, the position module 506 can determine the vehicle position 226 of the surrounding vehicle 220 relative to the current location 204.

The position module 506 can determine the vehicle position 226 in a number of ways. As discussed above, the capturing device 306 can detect the surrounding vehicle 220. As a result, the position module 506 can determine the vehicle position 226 relative to the current location 204 of the first device 102, the user's vehicle 218, or a combination thereof. More specifically as an example, the position module 506 can determine whether the vehicle position 226 is in each of the cardinal directions, intercardinal directions, or a combination thereof relative to the current location 204.

For another example, the position module 506 can determine the vehicle position 226 based on the vehicle distance 224 of FIG. 2 meeting or exceeding the distance threshold 222 of FIG. 2. More specifically as an example, the position module 506 can determine the vehicle position 226 similar to the location unit 420 determining the current location 204 by determining the GPS coordinates of the surrounding vehicle 220. For further example, the position module 506 can determine the vehicle distance 224 between the current location 204 and the vehicle position 226 based on measuring the physical distance of the two GPS coordinates. For further example, the position module 506 can determine whether the vehicle distance 224 meets or exceeds the distance threshold 222 by comparing the physical distance between the current location 204 and the vehicle position 226 to the distance threshold 222. As one example, the position module 506 can determine that the vehicle position 226 is within the vicinity of the current location 204 if the vehicle distance 224 between the current location 204 and the vehicle position 226 meets or below the distance threshold 222. The position module 506 can transmit the vehicle position 226 to a profile module 508.

The navigation system 100 can include the profile module 508, which can be coupled to the position module 506. The profile module 508 generates the operation profile 310 of FIG. 3. For example, the profile module 508 can generate the operation profile 310 based on the user's vehicle 218, the surrounding vehicle 220, the operation pattern 314 of FIG. 3, the vehicle distance 224, or a combination thereof.

The profile module 508 can generate the operation profile 310 in a number of ways. For example, the profile module 508 can generate the operation profile 310 based on the operation pattern 314 of the user's vehicle 218. More specifically as an example, the profile module 508 can determine the operation pattern 314 of the user's vehicle 218 based on the activity history 316 of FIG. 3. For a specific example, the activity history 316 can include a record of activity within the geographic area 206, the road type 208, the vehicle type 228, the travel speed 214, the operation heading 318 of FIG. 3, or a combination thereof.

For a further example, the profile module 508 can determine the operation pattern 314 based on the tracking the GPS coordinates of the user's vehicle 218 traveling from a point of interest to another point of interest, the travel speed 214, the operation heading 318, or a combination thereof. More specifically as an example, the profile module 508 can determine the operation pattern 314 including whether the user's vehicle 218 is operated with the vehicle distance 224 meeting or exceeding the distance threshold 222 from the surrounding vehicle 220. The profile module 508 can track the operation pattern 314 including the frequency of change in the operation heading 318, the travel speed 214 meeting or exceeding the speed limit 216, the vehicle distance 224 meeting or exceeding the distance threshold 222 to generate the operation profile 310 of the user's vehicle 218. The profile module 508 can generate and update the operation profile 310, the activity history 316, the operation pattern 314, or a combination thereof dynamically and in real time by tracking the current location 204 of the user's vehicle 218.

For a different example, the profile module 508 can generate the operation profile 310 based on the operation pattern 314 of the surrounding vehicle 220 similarly to the profile module 508 determining the operation profile 310 for the user's vehicle 218. The surrounding vehicle 220 can represent another vehicle different from the user's vehicle 218 traveling along the road type 208. More specifically as an example, the profile module 508 can determine the operation pattern 314 of the surrounding vehicle 220 based on the activity history 316. For a specific example, the activity history 316 can include a record of activity within the geographic area 206, the road type 208, the vehicle type 228, the travel speed 214, the operation heading 318, or a combination thereof.

For a further example, the profile module 508 can determine the operation pattern 314 based on the tracking the GPS coordinates of the surrounding vehicle 220 traveling from a point of interest to another point of interest, the travel speed 214, the operation heading 318, or a combination thereof. More specifically as an example, the profile module 508 can determine the operation pattern 314 including whether the surrounding vehicle 220 is operated with the vehicle distance 224 meeting or exceeding the distance threshold 222 from the user's vehicle 218, the other instance of the surrounding vehicle 220, or a combination thereof. The profile module 508 can track the operation pattern 314 including the frequency of change in the operation heading 318, the travel speed 214 meeting or exceeding the speed limit 216, the vehicle distance 224 meeting or exceeding the distance threshold 222 to generate the operation profile 310 of the surrounding vehicle. The profile module 508 can generate and update the operation profile 310, the activity history 316, the operation pattern 314, or a combination thereof dynamically and in real time by tracking the vehicle position 226 of the surrounding vehicle 220.

For further example, the profile module 508 can generate the operation profile 310 for the user's vehicle 218, the surrounding vehicle 220, or a combination thereof by tracking the user's vehicle 218, the surrounding vehicle 220, or a combination thereof simultaneously and in real-time. The profile module 508 can generate the operation profile 310 for the user's vehicle 218 that is different from the operation profile 310 for the surrounding vehicle 220. The profile module 508 can transmit the operation profile 310 to a control module 510.

The navigation system 100 can include the control module 510, which can be coupled to the profile module 508. The control module 510 controls the vehicle operation 302 of FIG. 3. For example, the control module 510 can control the vehicle operation 302 based on the travel context 202, the vehicle type 228, the current location 204, the vehicle position 226, the operation profile 310, the vehicle distance 224, the distance threshold 222, or a combination thereof.

The control module 510 can control the vehicle operation 302 in a number of ways. For example, the control module 510 can control the vehicle operation 302 representing a cruise control of the user's vehicle 218. More specifically as an example, the control module 510 can control the vehicle operation 302 by adjusting the vehicle distance 224, the distance threshold 222, or a combination thereof based on the vehicle type 228.

For a specific example, the control module 510 can set the vehicle distance 224, the distance threshold 222, or a combination thereof for one kind of the vehicle type 228 differently from another kind of the vehicle type 228. More specifically as an example, the user's vehicle 218 can represent a passenger vehicle and the surrounding vehicle 220 can represent a bus. The control module 510 can set a greater distance for the vehicle distance 224, the distance threshold 222, or a combination thereof for the vehicle type 228 representing the bus or truck compared to the vehicle type 228 representing a passenger vehicle.

Continuing with the example, if the surrounding vehicle 220 is a bus, the control module 510 can set the vehicle distance 224, the distance threshold 222, or a combination thereof for the physical distance calculated by 3 car rule, 3 second rule, or a combination thereof. The 3 car rule can represent the vehicle distance 224, the distance threshold 222, or a combination thereof calculated based on the physical distance equivalent to the length of three vehicles. The 3 second rule can represent the vehicle distance 224, the distance threshold 222, or a combination thereof calculated based on the physical distance that can be traveled within 3 seconds by the vehicle.

Continuing with the example, the surrounding vehicle 220 can represent a bus. The control module 510 can set the distance threshold 222 at 3 car rule, 3 second rule, or a combination thereof. The vehicle position 226 of the bus can be in front of the user's vehicle 218. The control module 510 can control the vehicle operation 302 representing a cruise control by increasing or decreasing the travel speed 214 to maintain the vehicle distance 224 meeting or exceeding the distance threshold 222 between the bus and the user's vehicle 218.

If the surrounding vehicle 220 is another passenger vehicle, the control module 510 can set the distance threshold 222 at a lower value such as 1 car rule, 1 second rule, or a combination thereof. The control module 510 can control the vehicle operation 302 representing a cruise control by increasing or decreasing the travel speed 214 to maintain the vehicle distance 224 meeting or exceeding the distance threshold 222 between the another passenger vehicle and the user's vehicle 218. The control module 510 can dynamically and in real time adjust the vehicle distance 224, the distance threshold 222, or a combination thereof based on the vehicle type 228 of the surrounding vehicle 220 to dynamically control the vehicle operation 302 of the user's vehicle 218.

For another example, the control module 510 can set the vehicle distance 224, the distance threshold 222, or a combination thereof for one kind of the vehicle attribute 320 differently from another kind of the vehicle attribute 320. For a specific example, the vehicle attribute 320 can represent the vehicle feature 322 representing “oversized load.” The control module 510 can set the vehicle distance 224, the distance threshold 222, or a combination thereof for the surrounding vehicle 220 having the vehicle feature 322 of “oversized load” with a greater distance than the surrounding vehicle 220 without the vehicle feature 322 of “oversized load.” More specifically as an example, the control module 510 can control the vehicle operation 302 representing a cruise control by increasing or decreasing the travel speed 214 to maintain the vehicle distance 224 meeting or exceeding the distance threshold 222 between the surrounding vehicle 220 with the vehicle feature 322 and the user's vehicle 218.

For a different example, the vehicle attribute 320 can represent the addendum feature 324. The addendum feature 324 can represent “student driver,” “baby on board,” or a combination thereof. The control module 510 can set the vehicle distance 224, the distance threshold 222, or a combination thereof for the surrounding vehicle 220 having the addendum feature 324 with a greater distance than the surrounding vehicle 220 without the addendum feature 324. Similar to above, the control module 510 can dynamically and in real time adjust the vehicle distance 224, the distance threshold 222, or a combination thereof based on the vehicle attribute 320 of the surrounding vehicle 220 to dynamically control the vehicle operation 302 of the user's vehicle 218. More specifically as an example, the control module 510 can control the vehicle operation 302 representing a cruise control by increasing or decreasing the travel speed 214 to maintain the vehicle distance 224 meeting or exceeding the distance threshold 222 between the surrounding vehicle 220 with the addendum feature 324 and the user's vehicle 218.

For another example, the user's vehicle 218 can include the vehicle attribute 320. More specifically as an example, the user's vehicle 218 can include the addendum feature 324 representing “baby on board.” Based on the addendum feature 324, the control module 510 can control the vehicle operation 302 by controlling the travel speed 214 of the user's vehicle 218 by slowing down the travel speed 214 of the user's vehicle 218 compared to if the user's vehicle 218 did not have the addendum feature 324. More specifically as an example, the control module 510 can control the vehicle operation 302 representing a cruise control by increasing or decreasing the travel speed 214 to maintain the vehicle distance 224 meeting or exceeding the distance threshold 222 between the surrounding vehicle 220 and the user's vehicle 218 with the addendum feature 324.

For a different example, the control module 510 can control the vehicle operation 302 based on the operation profile 310. As discussed above, the operation profile 310 including the operation pattern 314 of the user's vehicle 218, the surrounding vehicle 220, or a combination thereof can be tracked in real-time. For example, the operation pattern 314 of the surrounding vehicle 220 can indicate that the surrounding vehicle 220 cannot stay within the lane and constantly hitting the lane boundaries. The control module 510 can set the vehicle distance 224, the distance threshold 222, or a combination thereof for the surrounding vehicle 220 having the operation pattern 314 discussed above with a greater distance than the surrounding vehicle 220 without the operation pattern 314 discussed above. Similar to above, the control module 510 can dynamically and in real time adjust the vehicle distance 224, the distance threshold 222, or a combination thereof based on the operation profile 310 of the surrounding vehicle 220 to dynamically control the vehicle operation 302 of the user's vehicle 218.

For another example, the control module 510 can control the vehicle operation 302 based on the operation profile 310 representing the driver profile 312 of FIG. 3. More specifically as an example, if the driver profile 312 of the user's vehicle 218 can represent an elderly who is above the age of 65 or an adolescent who is below the age of 18, the control module 510 can set the vehicle distance 224, the distance threshold 222, or a combination thereof from the surrounding vehicle 220 with a greater distance than the surrounding vehicle 220 than the driver of the user's vehicle 218 without the driver profile 312 discussed above. The control module 510 can dynamically and in real time adjust the vehicle distance 224, the distance threshold 222, or a combination thereof based on the driver profile 312 of the user's vehicle 218 to dynamically control the vehicle operation 302 of the user's vehicle 218.

For a different example, the control module 510 can control the vehicle operation 302 based on the vehicle distance 224 between the user's vehicle 218 and the surrounding vehicle 220. The vehicle position 226 of the surrounding vehicle 220 can represent behind the user's vehicle 218. More specifically as an example, the vehicle distance 224 between the user's vehicle 218 and the surrounding vehicle 220 can be less than the distance threshold 222. The control module 510 can control the vehicle operation 302 by increasing the travel speed 214 to increase the vehicle distance 224 to meet or exceed the distance threshold 222 between the user's vehicle 218 and the surrounding vehicle 220.

For a different example, the control module 510 can control the vehicle operation 302 based on the special vehicle 230. The special vehicle 230 can represent an ambulance. The control module 510 can set the vehicle distance 224, the distance threshold 222, or a combination thereof for the special vehicle 230 differently from another kind of the vehicle type 228 that is not the special vehicle 230. More specifically as an example, the user's vehicle 218 can represent a passenger vehicle and the special vehicle 230 can represent the ambulance. The control module 510 can set a greater distance for the vehicle distance 224, the distance threshold 222, or a combination thereof for the ambulance compared to the vehicle type 228 representing a passenger vehicle. The control module 510 can control the vehicle operation 302 to change lane if the vehicle distance 224 meets or below the distance threshold 222 between the special vehicle 230 and the user's vehicle 218.

For a different example, the control module 510 can control the vehicle operation 302 based on the travel context 202. The control module 510 can set the vehicle distance 224, the distance threshold 222, or a combination thereof for the one condition for the travel context 202 differently from another condition of the travel context 202. For a specific example, the control module 510 can set the vehicle distance 224, the distance threshold 222, or a combination thereof for traveling in the travel context 202 of rain, at night, or a combination thereof with a greater distance than the travel context 202 of no rain, during the day, or a combination thereof.

For a different example, the control module 510 can control the vehicle operation 302 based on prioritizing each of the travel context 202, the vehicle type 228, the vehicle position 226, the operation profile 310, the vehicle distance 224, the distance threshold 222, the vehicle attribute 320, or a combination thereof over another. More specifically as an example, the control module 510 can set a higher priority for one factor over another to control the vehicle operation 302 based on each of the factor.

For example, the control module 510 can prioritize the vehicle type 228 over the operation profile 310 based on the travel context 202. More specifically as an example, the travel context 202 can represent car accident on the road type 208 representing a freeway. The control module 510 can prioritize the vehicle type 228 representing the special vehicle 230 over the operation profile 310 to allow the control module 510 to control the vehicle operation 302 adjusted to respond to the special vehicle 230 approaching the user's vehicle 218.

It has been discovered that the navigation system 100 controlling the vehicle operation 302 based on the travel context 202, the vehicle type 228, the current location 204, the vehicle position 226, the operation profile 310, the vehicle distance 224, the distance threshold 222, or a combination thereof improves the efficiency, the performance, or a combination thereof of the navigation system 100, the user's vehicle 218, or a combination thereof. By adjusting the vehicle operation 302 according to the travel context 202, the vehicle type 228, the current location 204, the vehicle position 226, the operation profile 310, the vehicle distance 224, the distance threshold 222, or a combination thereof surrounding the user's vehicle 218, the navigation system 100 can allocate the computing resource efficiently to granularly control the vehicle operation 302 suited for the travel context 202. As a result, the performance of the user's vehicle 218 improves for the safer operation of the navigation system 100, the user's vehicle 218, or a combination thereof.

The physical transformation from determining the travel context 202, the surrounding vehicle 220, the vehicle position 226, the operation profile 310, or a combination thereof results in the movement in the physical world, such as people using the first device 102, the vehicle, or a combination thereof, based on the operation of the navigation system 100, the user's vehicle 218, or a combination thereof. As the movement in the physical world occurs, the movement itself creates additional information that is transformed from physical aspect to digital data for further control of the vehicle operation 302 for the continued operation of the navigation system 100, the user's vehicle 218, or a combination thereof and to continue the movement in the physical world.

The first software 426 of FIG. 4 of the first device 102 of FIG. 4 can include the modules for the navigation system 100. For example, the first software 426 can include the context module 502, the surrounding module 504, the position module 506, the profile module 508, and the control module 510. The first control unit 412 of FIG. 4 can execute the modules to perform the functions dynamically and in real-time.

The first control unit 412 can execute the first software 426 for the context module 502 to determine the travel context 202. The first control unit 412 can execute the first software 426 for the surrounding module 504 to determine the surrounding vehicle 220. The first control unit 412 can execute the first software 426 for the position module 506 to determine the vehicle position 226. The first control unit 412 can execute the first software 426 for the profile module 508 to generate the operation profile 310. The first control unit 412 can execute the first software 426 for the control module 510 to control the vehicle operation 302.

The second software 442 of FIG. 4 of the first device 102 of FIG. 4 can include the modules for the navigation system 100. For example, the second software 442 can include the context module 502, the surrounding module 504, the position module 506, the profile module 508, and the control module 510. The second control unit 434 of FIG. 4 can execute the modules to perform the functions dynamically and in real-time.

The second control unit 434 can execute the second software 442 for the context module 502 to determine the travel context 202. The second control unit 434 can execute the second software 442 for the surrounding module 504 to determine the surrounding vehicle 220. The second control unit 434 can execute the second software 442 for the position module 506 to determine the vehicle position 226. The second control unit 434 can execute the second software 442 for the profile module 508 to generate the operation profile 310. The second control unit 434 can execute the second software 442 for the control module 510 to control the vehicle operation 302.

The modules of the navigation system 100 can be partitioned between the first software 426 and the second software 442. The second software 442 can include the context module 502, the surrounding module 504, the position module 506, and the profile module 508. The second control unit 434 can execute modules partitioned on the second software 442 as previously described.

The first software 426 can include the control module 510. Based on the size of the first storage unit 414, the first software 426 can include additional modules of the navigation system 100. The first control unit 412 can execute the modules partitioned on the first software 426 as previously described.

It has been discovered that the navigation system 100 having different configuration of a distributed architecture to actuate each module on the first device 102 or the second device 106 enhances the capability to determine the travel context 202, the surrounding vehicle 220, the vehicle position 226, the operation pattern 314, or a combination thereof. By having the distributed architecture, the navigation system 100 can enable load distribution to receive the information related to the travel context 202, the surrounding vehicle 220, the vehicle position 226, the operation pattern 314, or a combination thereof to reduce congestion in bottleneck in the communication path 104 and enhance the capability of the navigation system 100. As a result, the navigation system 100 can improve the performance to control the traffic flow for controlling the vehicle operation 302 for safer operation of the first device 102, the vehicle, or a combination thereof.

The first control unit 412 can operate the first communication unit 416 of FIG. 4 to the travel context 202, the surrounding vehicle 220, the vehicle position 226, the operation profile 310, the vehicle operation 302, or a combination thereof to or from the second device 106 through the communication path 104. The first control unit 412 can operate the first software 426 to operate the location unit 420. The second control unit 434 can operate the second communication unit 436 of FIG. 4 to transmit the travel context 202, the surrounding vehicle 220, the vehicle position 226, the operation profile 310, the vehicle operation 302, or a combination thereof to or from the first device 102 through the communication path 104.

The navigation system 100 describes the module functions or order as an example. The modules can be partitioned differently. For example, the surrounding module 504 and the position module 506 can be combined. Each of the modules can operate individually and independently of the other modules. Furthermore, data generated in one module can be used by another module without being directly coupled to each other. For example, the control module 510 can receive the travel context 202 from the context module 502. Further, one module transmitting to another module can represent one module communicating, sending, receiving, or a combination thereof the data generated to or from another module.

The modules described in this application can be hardware implementation or hardware accelerators in the first control unit 412 or in the second control unit 434. The modules can also be hardware implementation or hardware accelerators within the first device 102 or the second device 106 but outside of the first control unit 412 or the second control unit 434, respectively as depicted in FIG. 4. However, it is understood that the first control unit 412, the second control unit 434, or a combination thereof can collectively refer to all hardware accelerators for the modules. Furthermore, the first control unit 412, the second control unit 434, or a combination thereof can be implemented as software, hardware, or a combination thereof.

The modules described in this application can be implemented as instructions stored on a non-transitory computer readable medium to be executed by the first control unit 412, the second control unit 434, or a combination thereof. The non-transitory computer medium can include the first storage unit 414, the second storage unit 446 of FIG. 4, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the navigation system 100 or installed as a removable portion of the navigation system 100.

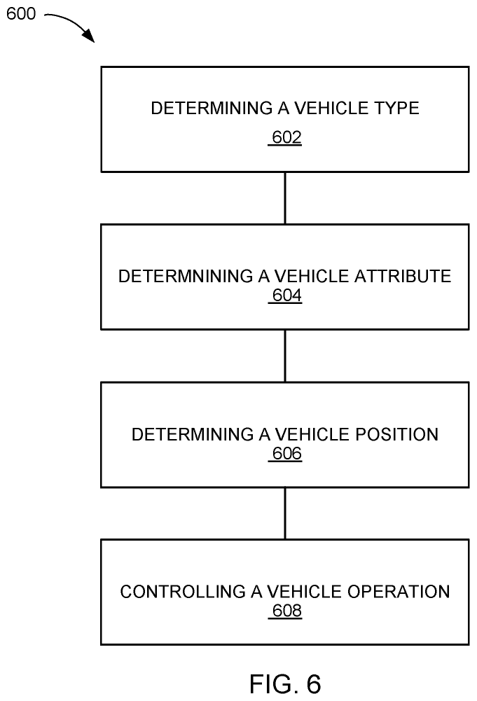

Referring now to FIG. 6, therein is shown a flow chart of a method 600 of operation of the navigation system 100 in a further embodiment of the present invention. The method 600 includes: determining a vehicle type of a surrounding vehicle based on comparing a capture data to a trained data in a block 602; determining a vehicle attribute of the surrounding vehicle based on comparing the capture data to the trained data in a block 604; determining a vehicle position relative to a current location based on a vehicle distance meeting or exceeding a distance threshold in a block 606; and controlling a vehicle operation with a control unit based on the vehicle type, the vehicle attribute, the vehicle position, or a combination thereof for adjusting the vehicle distance between a user's vehicle and a surrounding vehicle in a block 608.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
determining a vehicle type of a surrounding vehicle based on comparing a capture data to a trained data;
determining a vehicle attribute of the surrounding vehicle based on comparing the capture data to the trained data;
determining a vehicle position relative to a current location based on a vehicle distance meeting or exceeding a distance threshold; and
controlling a vehicle operation with a control unit based on the vehicle type, the vehicle attribute, the vehicle position, or a combination thereof for adjusting the vehicle distance between a user's vehicle and a surrounding vehicle.

2. The method as claimed in claim 1 further comprising determining a travel context based on the current location for traveling in a geographic area.

3. The method as claimed in claim 1 further comprising generating an operation profile based on an operation pattern of the user's vehicle.

4. The method as claimed in claim 1 wherein controlling the vehicle operation includes controlling the vehicle operation based on determining an addendum feature for changing a travel speed.

5. The method as claimed in claim 1 wherein controlling the vehicle operation includes controlling the vehicle operation based on an operation profile for adjusting the vehicle distance between the user's vehicle and the surrounding vehicle.

6. The method as claimed in claim 1 wherein controlling the vehicle operation includes controlling the vehicle operation by prioritizing the vehicle type over the vehicle attribute based on a travel context.

7. The method as claimed in claim 1 wherein controlling the vehicle operation includes controlling the vehicle operation by prioritizing the vehicle attribute over the vehicle type based on a travel context.

8. The method as claimed in claim 1 wherein controlling the vehicle operation includes setting the vehicle distance, the distance threshold, or a combination thereof for the vehicle type different from another different instance of the vehicle type for adjusting the vehicle distance between the user's vehicle and the surrounding vehicle.

9. The method as claimed in claim 1 wherein controlling the vehicle operation includes setting the vehicle distance, the distance threshold, or a combination thereof for the vehicle attribute different from another different instance of the vehicle attribute for adjusting the vehicle distance between the user's vehicle and the surrounding vehicle.

10. The method as claimed in claim 1 further comprising determining an operation pattern based on the vehicle between the user's vehicle and the surrounding vehicle meets, exceeds, or below the distance threshold.

11. A navigation system comprising:
a control unit for:
determining a vehicle type of a surrounding vehicle based on comparing a capture data to a trained data;
determining a vehicle attribute of the surrounding vehicle based on comparing the capture data to the trained data;
determining a vehicle position relative to a current location based on a vehicle distance meeting or exceeding a distance threshold;
controlling a vehicle operation based on the vehicle type, the vehicle attribute, the vehicle position, or a combination thereof; and
a communication unit, coupled to the control unit, for transmitting the vehicle operation for adjusting the vehicle distance between a user's vehicle and a surrounding vehicle.

12. The system as claimed in claim 11 wherein the control unit is for determining a travel context based on the current location for traveling in a geographic area.

13. The system as claimed in claim 11 wherein the control unit is for generating an operation profile based on an operation pattern of the user's vehicle.

14. The system as claimed in claim 11 wherein the control unit is for controlling the vehicle operation based on determining an addendum feature for changing a travel speed.

15. The system as claimed in claim 11 wherein the control unit is for controlling the vehicle operation based on an operation profile for adjusting the vehicle distance between the user's vehicle and the surrounding vehicle.

16. A non-transitory computer readable medium including instructions for execution, the instructions comprising:
determining a vehicle type of a surrounding vehicle based on comparing a capture data to a trained data;
determining a vehicle attribute of the surrounding vehicle based on comparing the capture data to the trained data;
determining a vehicle position relative to a current location based on a vehicle distance meeting or exceeding a distance threshold; and
controlling a vehicle operation based on the vehicle type, the vehicle attribute, the vehicle position, or a combination thereof for adjusting the vehicle distance between a user's vehicle and a surrounding vehicle.

17. The non-transitory computer readable medium as claimed in claim 16 further comprising determining a travel context based on the current location for traveling in a geographic area.

18. The non-transitory computer readable medium as claimed in claim 16 further comprising generating an operation profile based on an operation pattern of the user's vehicle.

19. The non-transitory computer readable medium as claimed in claim 16 wherein controlling the vehicle operation includes controlling the vehicle operation based on determining an addendum feature for changing a travel speed.

20. The non-transitory computer readable medium as claimed in claim 16 wherein controlling the vehicle operation includes controlling the vehicle operation based on an operation profile for adjusting the vehicle distance between the user's vehicle and the surrounding vehicle.
